(19) United States
(12) Patent Application Publication
(10) Pub. No.: US 2006/0224512 A1
(43) Pub. Date: Oct. 5, 2006

(54) Delivery management system and delivery cabinet

(75) Inventor: Takahiro Kurakata, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/157,815

(22) Filed: Jun. 22, 2005

(30) Foreign Application Priority Data
Mar. 29, 2005 (JP) 2005-093954

(51) Int. Cl. G06Q 99/00

(52) U.S. Cl. 705/50

(57) ABSTRACT

The present invention provides a delivery management system including a public key storage unit for storing a public key of the addressee; a secret key input unit for inputting a secret key of the addressee; and an authentication unit for authenticating the addressee on the basis of the secret key inputted by the secret key input unit and the public key stored in the public key storage unit. Thereby, it is possible to grasp that the addressee receives the delivery so as to improve a reliability of the deliver.

### BACKGROUND OF THE INVENTION

(1) Field of the Invention

The present invention relates to an art for keeping a delivery when the addressee thereof is abscent.

(2) Description of the Related Art

Conventionally, various countermeasures have been taken in a case where an addressee cannot receive a package, for example, due to absence of the addressee when the package is delivered via parcel delivery service or the like.

For example, if there is a person who can receive the package in place of the addressee such as a cohabiter of the addressee or a superintendent of an apartment building, these agents may receive the package in place of the addressee. In addition, dropping an absence notice in a letterbox of the addressee, the package may be delivered again when the addressee stays home.

Further, if an absence box is arranged, a deliverer can drop the package in this absence box.

In addition, for example, Japanese patent application Laid-open No. 2002-114332 discloses a method in which a deliverer of the package issues a card key to the addressee of the package and the addressee unlocks storage means with a key by using this card key and individual authentication information (a telephone number or the like) to receive the package.

However, according to the above-described conventional parcel delivery service, there is a problem that it cannot be confirmed that the addressee himself or herself has certainly received the package and further, it cannot be confirmed that the person who receives the package is the addressee himself or herself. For example, even if the family of the addressee receives the package, it cannot be confirmed that the addressee certainly receives it from the family. Alternatively, for example, there is a possibility that an evil-minded person pretends to be the addressee to receive the package.

### SUMMARY OF THE INVENTION

The present invention has been made taking the foregoing problems into consideration and an object of which is to improve reliability of delivery by making it possible to grasp that the addressee has received the delivery.

Therefore, a delivery management system for managing the information about a delivery delivered to an addressee according to the present invention may comprise a public key storage unit for storing a public key of the addressee; a secret key input unit for inputting a secret key of the addressee; and an authentication unit for authenticating the addressee on the basis of the secret key inputted by the secret key input unit and the public key stored in the public key storage unit.

In the meantime, the delivery management system may comprise a delivery cabinet and a management server communicatably connected to the delivery cabinet via a communication network; wherein the delivery cabinet including: the secret key input unit; a delivery storage unit for storing the delivery delivered to the addressee; a locking unit for locking the delivery storage unit; an addressee information input unit for inputting the addressee information for specifying the addressee; an authentication data generating unit for generating the authentication data by adding a digital signature created by using the secret key inputted by the secret key input unit to the authentication information including the addressee information; a transmission unit for transmitting the authentication data created by the authentication data generating unit to the management server via the communication network; and an unlocking unit for unlocking the delivery storage unit locked by the locking unit when the addressee is identified by the authentication unit; wherein the management server comprising the public key storage unit, the authentication unit, and unlocking instruction unit for instructing the unlocking unit to unlock the delivery storage unit when the addressee is identified by the authentication unit; wherein the authentication unit authenticates the addressee by decoding the digital signature added to the authentication data transmitted from the transmission unit by using the public key; and wherein the unlocking unit unlocks the delivery storage unit in accordance with an unlocking instruction of the unlocking instruction unit.

In addition, the delivery management system may comprise a portable terminal that a deliverer can carry with him or her and a management server communicatably connected to the delivery cabinet via a communication network; wherein the portable terminal including: the secret key input unit; an addressee information input unit for inputting the addressee information for specifying the addressee; an authentication data generating unit for generating the authentication data by adding a digital signature created by using the secret key inputted by the secret key input unit to the authentication information including the addressee information; and a transmission unit for transmitting the authentication data created by the authentication data generating unit to the management server via the communication network; wherein the management server comprising the public key storage unit and the authentication unit; and wherein the authentication unit authenticates the addressee by decoding the digital signature added to the authentication data transmitted from the transmission unit by using the public key.

Further, the authentication unit may authenticate the addressee on the basis of the addressee information added with the verification information and the public key.

In addition, the authentication unit may comprise a delivery completion notice unit for giving a notice of completion of the delivery to a person who requests delivery to the addressee when the addressee receives the delivery.

Further, the secret key of the addressee may be readably stored in a medium that the addressee can carry with him or her, and the secret key input unit may be configured as a reading apparatus capable of reading the secret key from the medium.

Further, a delivery cabinet according to the present invention for keeping a delivery delivered to the addressee may comprise a delivery storage unit for storing the delivery that is delivered to the addressee; a locking unit for locking the delivery storage unit; a secret key input unit for inputting the secret key of the addressee; and an unlocking unit for unlocking the delivery storage unit that is locked by the locking unit when the addressee is identified as a result of authentication of the addressee carried out on the basis of the secret key inputted by the secret key input unit.

In the meantime, the delivery cabinet may comprise an addressee information input unit for inputting the addressee information for specifying the addressee; an authentication data generating unit for generating the authentication data by adding a digital signature created by using the secret key inputted by the secret key input unit to the authentication information including the addressee information; and a transmission unit for transmitting the authentication data created by the authentication data generating unit to the authentication server that is communicatably connected to the delivery cabinet via the communication network; wherein the unlocking unit unlocks the delivery storage unit when the addressee is identified by the authentication server.

In addition, the secret key of the addressee may be readably stored in a medium that the addressee can carry with him or her, and the secret key input unit may be configured as a reading apparatus capable of reading the secret key from the medium.

According to the present invention, it is possible to manage or confirm that the addressee himself or herself has received the delivery and this leads to improve the reliability of the delivery. In addition, by authenticating the addressee using a PKI (Public Key Infrastructure) technology, it is possible to prevent others from pretending to be the addressee and thereby, the reliability of the delivery can be improved.

### BRIEF DESCRIPTION OF THE DRAWINGS

FIG. 1 is a pattern diagram showing a structure of a delivery management system of a first embodiment according to the present invention;

FIG. 2 shows a data structure of a memory in an IC card (medium) that is used in the delivery management system of the first embodiment according to the present invention;

FIG. 3 shows an example of the data for authentication that is generated by an authentication data generating unit of the delivery management system of the first embodiment according to the present invention;

FIG. 4 shows an example of a user information database in the delivery management system of the first embodiment according to the present invention;

FIG. 5 shows an example of an absence box information database in the delivery management system of the first embodiment according to the present invention;

FIG. 6 shows an example of a package information database in the delivery management system of the first embodiment according to the present invention;

FIG. 7 is a flowchart for explaining a process of an authentication server when registering a new user (a preparation phase) in the delivery management system of the first embodiment according to the present invention;

FIG. 8 is a flowchart for explaining a process when operating the delivery management system of the first embodiment according to the present invention;

FIG. 9 is a pattern diagram showing a structure of a delivery management system of a second embodiment according to the present invention;

FIG. 10 is a flowchart for explaining a process when operating the delivery management system of the second embodiment according to the present invention; and

FIG. 11 is a pattern diagram showing a structure of a delivery management system of a third embodiment according to the present invention.

### DESCRIPTION OF THE PREFERRED EMBODIMENTS

The embodiments of the present invention will be described below with reference to the drawings.

### (A) Explanation of a First Embodiment

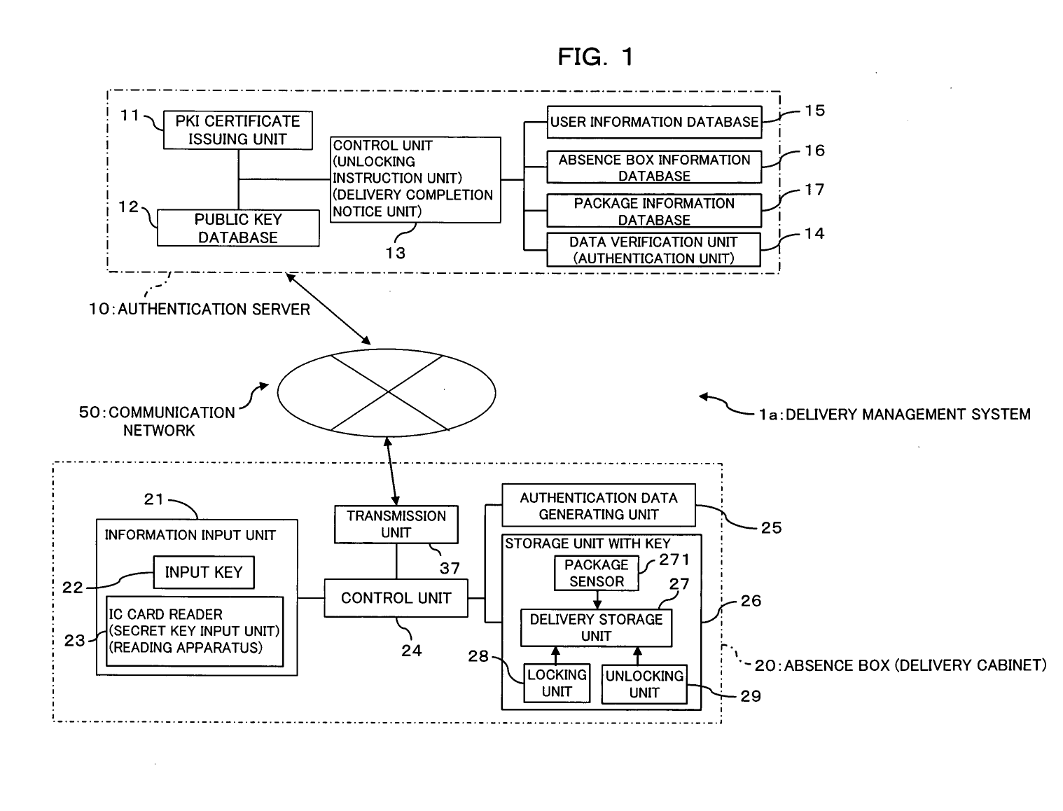

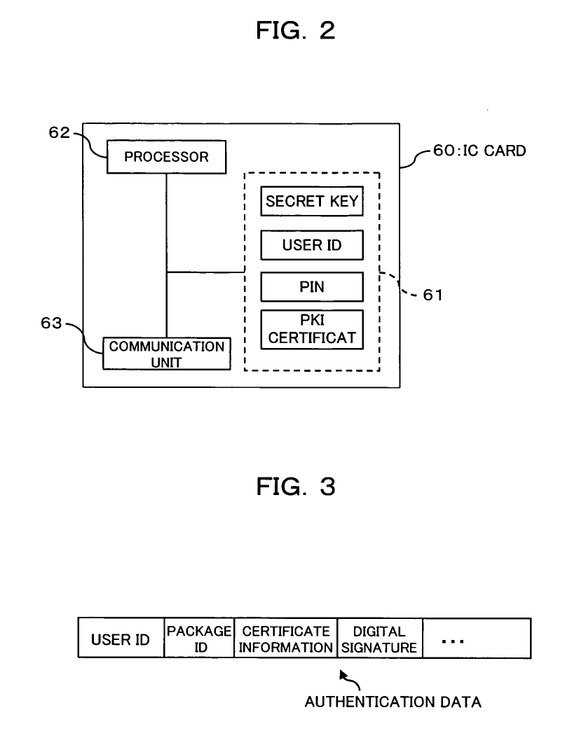

FIG. 1 is a pattern diagram showing a structure of a delivery management system of a first embodiment according to the present invention, and FIG. 2 shows a data structure of a memory in an IC card (medium) that is used in the delivery management system of the first embodiment according to the present invention. A delivery management system la according to the first embodiment of the present invention manages information about a delivery (package) that is delivered to an addressee, and as shown in FIG. 1, is configured by communicatably connecting an authentication server (management server) 10 to an absence box 20 via a communication network 50.

In the meantime, in the delivery management system 1a, a user ID (Identification) for specifying the user is set for each of the users that are the addressees of the delivery, and for each user, a key pair of a public key and a secret key has been generated in advance. These public key and secret key have unique values for each user.

As shown in FIG. 2, an IC card (medium) 60 is provided with a processor 62, a memory 61, and a communication unit 63, and each user holds this IC card 60. Then, according to the present embodiment, the IC card 60 is issued to each user, and the user manages and holds the IC card 60 so as to prevent other persons from using it.

The processor 62 serves to carry out various arithmetic processing by using a program and data stored in the memory 61, and the communication unit 63 is configured, for example, by a connection terminal or the like to be communicatably connected to an IC card reader 23 or the like (to be described later).

The memory 61 serves to store various programs and data, and as shown in FIG. 2, the secret key, a user ID, a PIN (Personal Identification Number: pass word), and a PKI certificate that are issued to the owner (the user, the addressee) of the IC card 60 are stored therein.

In the meantime, the PIN has been set in advance corresponding to the secret key, and the PKI certificate is issued by a PKI certificate issuing unit 11 of the authentication server 10 (to be described later).

The absence box 20 is provided to, for example, an entrance or the like of a residence of the addressee for the delivery, and when the addressee cannot receive the delivery due to absence, the deliverer stores the delivery in this absence box. As shown in FIG. 1, the absence box is provided with an information input unit 21, a control unit 24, an authentication data generating unit 25, a storage unit with a key 26, and a transmission unit 37.

The information input unit 21 serves to input various information, and is provided with an input key 22 and an IC card reader (a secret key input unit, a reading apparatus) 23. The input key 22 includes a numeric keypad, a keyboard, and a touch panel or the like for inputting a number and a character, and is used by the deliverer or addressee to input the user ID (the addressee information) for specifying the addressee, or a package ID for specifying the delivery (the package), and is used by the addressee to input a password (the details are described later).

The IC card reader 23 is a reading apparatus for reading the user ID and the secret key from the IC card 60 belonging to the user, and functions as the secret key input unit to input the secret key of the user (the addressee). In the meantime, this IC card reader 23 may read the user ID and the secret key by various methods such as electricity, magnetism, and electromagnetic wave or the like in accordance with the kinds of the IC card 60, and various modifications thereof, such as a contact type and a noncontact type or the like can be also executed.

The storage unit with a key 26 may store and keep the delivery delivered to the addressee, and is provided with a delivery storage unit 27, a locking unit 28, an unlocking unit 29, and a package sensor 271. The delivery storage unit 27 (namely, the box) serves to store the delivery therein, and the locking unit 28 serves to lock this delivery storage unit 27. An unlocking unit 29 serves to unlock the delivery storage unit 27 locked by the locking unit 28. The package sensor 271 is configured by, for example, an optical sensor or the like to detect that the package is stored in the delivery storage unit 27.

Then, the locking unit 28 may lock the delivery storage unit 27 on the basis of control of the control unit 24 in accordance with a locking instruction from the authentication server 10 (to be described later). In addition, the unlocking unit 29 serves to unlock the delivery storage unit 27 locked by the locking unit 28 on the basis of the control of the control unit 24 in accordance with an unlocking instruction from the authentication server 10 (to be described later).

In addition, the package sensor 271 may detect that the package is stored in the delivery storage unit 27 or the package is picked up from the delivery storage unit 27 to notify the control unit 24 of the fact.

In the meantime, in the delivery management system la according to the present embodiment, a plurality of storage units with a key 26 are provided to one absence box 20, and by giving unique numbers (the box number: a natural number in this embodiment) to the plurality of storage units with a key 26, respectively, each storage unit with a key 26 is identified.

In addition, in the present delivery management system la, a plurality of absence boxes 20 (two absence boxes 20 in this embodiment) are provided, and by giving unique identification information (an absence box ID: according to the example shown in FIG. 5, “XX mansion 01” and “XX building 01” or the like) to these plural absence boxes 20, respectively, each absence box 20 is identified. In the meantime, various modifications of identification information, for example, combinations of alphameric characters may be executed.

FIG. 3 shows an example of data for authentication that is generated by the authentication data generating unit 25 of the delivery management system la of the first embodiment according to the present invention.

The authentication data generating unit 25 may generate the data for authentication as shown in FIG. 3 by adding an electronic signature to be created using the secret key inputted by the IC card reader 23 to the information for authentication including the addressee information.

The electronic signature is created by coding a signature sentence using the secret key of the addressee. In the meantime, as for the signature sentence, a portion or the entirety of a plain sentence may be used.

As shown in FIG. 3, the authentication data generating unit 25 may generate the data for authentication (the data with a signature) about the addressee by adding the electronic signature and the information for a certificate to be created by using the secret key of the addressee that is acquired by the IC card reader 23 to the information for authentication including the user ID read from the IC card 60 by the IC card reader 23 and the package ID inputted by the input key 22.

The transmission unit 37 may transmit the data for authentication generated by the authentication data generating unit 25 to the authentication server 10 via the communication network 50, and for example, the transmission unit 37 is configured by, for example, a network device such as a LAN (Local Area Network) card and its control program or the like.

In addition, the transmission unit 37 may establish encrypted communication such as a SSL (Secure Socket Layer) with the authentication server 10, and thereby, the secure communication is made between the absence box 20 and the authentication server 10.

The control unit 24 may control the authentication data generating unit 25, the locking unit 28, the unlocking unit 29, the IC card reader 23, and the transmission unit 37. In addition, the control unit 24 may transmit the package receipt information (the delivery completion notice) to the authentication server 10 when the package sensor 271 of the storage unit with a key 26 detects that the package is picked up from the delivery storage unit 27.

In addition, the absence box 20 may be provided with a display apparatus for displaying information inputted by the input key 22, a processing result executed by the control unit 24, and a message to an operator or the like, and a sound output apparatus for representing these information by the sounds.

For example, the authentication server (management server) 10 is a computer system provided with a server function, and by executing a delivery management program by the CPU (Central Processing Unit: its illustration is herein omitted), the authentication server (management server) 10 may function as a PKI certificate issuing unit 11, a public key database (public key storage unit) 12, a control unit (an unlocking instruction unit, a delivery completion notice unit) 13, a data verification unit (an authentication unit) 14, a user information database 15, an absence box information database 16, and a package information database 17.

In the meantime, a program (a delivery management program) for realizing functions as these PKI certificate issuing unit 11, public key database 12, control unit 13, data verification unit 14, user information database 15, absence box information database 16, and package information database 17 maybe provided as being recorded in a recording medium capable of being read by a computer, for example, a flexible disk, a CD (a CD-ROM, a CD-R, a CD-RW or the like), a DVD (a DVD-ROM, a DVD-RAM, a DVD-R, a DVD+R, a DVD-RW, a DVD+RW or the like), a magnetic disk, an optical disk, and an optical magnetic disk or the like. Then, the computer may read the program from the recording medium, may transfer it to an inner storage apparatus or an outer storage apparatus, and may store it therein. In addition, by recording the program in the storage apparatus (the recording medium), for example, the magnetic disk, the optical disk, and the optical magnetic disk or the like, the program may be provided from this storage apparatus to the computer via a communication path.

When realizing the functions as the PKI certificate issuing unit 11, the public key database 12, the control unit 13, the data verification unit 14, the user information database 15, the absence box information database 16, and the package information database 17, the program stored in the inner storage apparatus (the RAM and the ROM of the management server 10 in the present embodiment) is executed by the microprocessor (the CPU in this embodiment) of the computer. In this case, the program recorded in the recording medium may be read by the computer to be executed.

In the meantime, according to the present embodiment, the computer represents an idea including hardware and an operating system, and means the hardware operating under the control of the operating system. In addition, in a case where the operating system is not required and the hardware is operated only by an application program, the hardware itself is equivalent to the computer. The hardware is provided with at least a microprocessor such as a CPU or the like and means for reading the computer program recorded in the recording medium. According to the present embodiment, the authentication server 10 has the function as the computer.

Further, as the recording medium according to the present embodiment, various media capable of being read by a computer, such as an IC card, a ROM card, a magnetic tape, a punch card, the inner storage apparatus of the computer (a memory such as the RAM and the ROM), the outer storage apparatus, and a printed matter on which a code such as a bar code is printed, in addition to the above-described flexible disk, CD (CD-ROM, CD-R,. CD-RW or the like), DVD (DVD-ROM, DVD-RAM, DVD-R, DVD+R, DVD-RW, DVD+RW or the like), magnetic disk, optical disk, and optical magnetic disk, can be used.

The PKI (Public Key Infrastructure) certificate issuing unit 11 may assure a level of reliance of the public key of the addressee and may certify that the public key of the addressee belongs to the addressee himself or herself (a certification authority) to issue the PKI certificate.

The public key database (public key storage unit) 12 may store and manage the public key of the user of this delivery management system la and may store the public key of the user by relating to the user ID or the like so as to enable to acquire the public key of the addressee on the basis of the user ID or the like of the addressee.

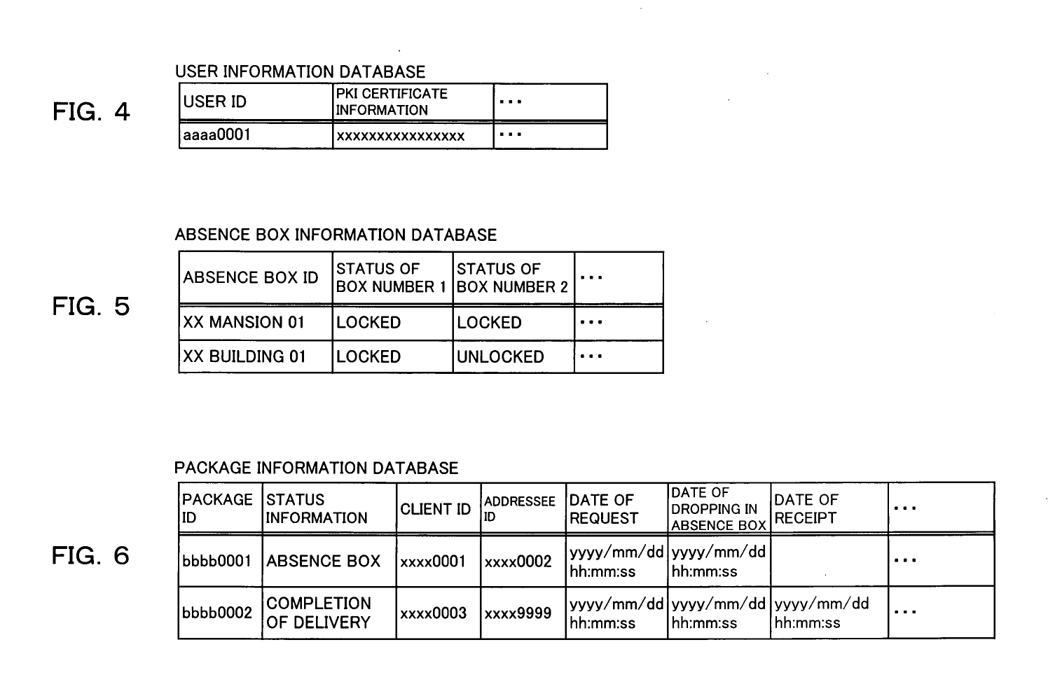

FIG. 4 shows an example of the user information database 15 in the delivery management system la of the first embodiment according to the present invention, FIG. 5 shows an example of the absence box information database 16 in the delivery management system of the first embodiment according to the present invention, and FIG. 6 shows an example of the package information database 17 in the delivery management system of the first embodiment according to the present invention.

The user information database 15 may manage information about the user, and as shown in FIG. 4, for example, is configured with the PKI certificate information or the like related to the user ID.

The absence box information database 16 may manage information about the absence box 20, and as shown in FIG. 5, for example, is configured with the information indicating a status (“locked” or “unlocked”) of each delivery storage unit 27 provided to the absence box related to the absence box ID.

The package information database 17 may manage information about the delivery (package) to be delivered, and as shown in FIG. 6, for example, is configured with status information, a client ID, an addressee ID, the date of request, the date of dropping the delivery in the absence box, and the date of receipt or the like related to the package ID.

The status information indicates the delivery status of the delivery, and according to the example shown in FIG. 6, information such as “absence box” indicating that the delivery has been dropped in the absence box , “completion of delivery” indicating that the delivery has been received by the addressee, or the like is stored in the status information.

The client ID is the information for specifying the client of delivery and the addressee ID is the information for specifying the addressee. In addition, the date of request is the information for specifying a date when the delivery is requested; the date of dropping the delivery in the absence box 20 is the information for specifying a date when the delivery is dropped in the absence box 20 to be registered in a case where the delivery is dropped in the absence box 20. The date of receipt is the information for specifying a date when the addressee receives the delivery to be registered in a case where the addressee receives the delivery.

The data verification unit 14 may authenticate that the addressee is valid by decoding the electronic signature added to the data for authentication (the data with the electronic signature) transmitted from the transmission unit 37 of the absence box 20 using the public key of the addressee that is acquired from the public key database 12.

In the meantime, in the case of using a message digest as the electronic signature, the data verification unit 14 may decode the electronic signature (the code digest) added to the received data for authentication by the public key of the addressee and may generate the message digest from the received plain sentence by using the same message compression art (a hash function) as that of the addressee. Then, by comparing the message digest acquired by decoding the code digest with the message digest generated from the plain sentence, when two message digests are identical, the validity of the data for authentication transmitted from the addressee is confirmed. In other words, thereby, it is possible to realize the identification of the addressee and identification of falsification of the data for authentication.

Thus, the data verification unit 14 may function as the authentication unit for identifying the addressee on the basis of the secret key inputted by the IC card reader 23 and the public key of the addressee.

The control unit 13 may control the PKI certificate issuing unit 11, the public key database 12, the data verification unit 14, the user information database 15, the absence box information database 16, and the package information database 17.

In addition, the control unit (unlocking instruction unit) 13 may give an unlock instruction to the unlocking unit 29 via the control unit 24 of the absence box 20 when the addressee is identified by the data verification unit 14.

Further, the control unit (delivery completion notice unit) 13 may notify the client who requested the delivery to the addressee that the delivery is completed (the delivery completion notice) when the control unit 13 is notified from the absence box 20 that the delivery is picked up (the package receipt notice) from the delivery storage unit 27.

For example, the control unit 13 has registered the electronic mail address and the contact address of the client of the package in advance and when receiving the package receipt notice from the absence box 20, the control unit 13 may notify the client that the delivery has been completed by means such as an electronic mail, a telephone, a facsimile, and a mailing card or the like.

In addition, the control unit 13 may carry out each updating of the public key database 12, the user information database 15, the absence box information database 16, and the package information database 17. The control unit 13 may update, for example, the status information (“locked”, “unlocked”) in the absence box information database 16 and the information such as the date of dropping the delivery in the absence box and the date of receipt or the like in the package information database 17 on the basis of each kind of information to be transmitted from the absence box 20.

The communication network 50 may connect the authentication server 10 to the absence box 20 communicatably, and for example, this connection is realized by a LAN (Local Area Network) or the like.

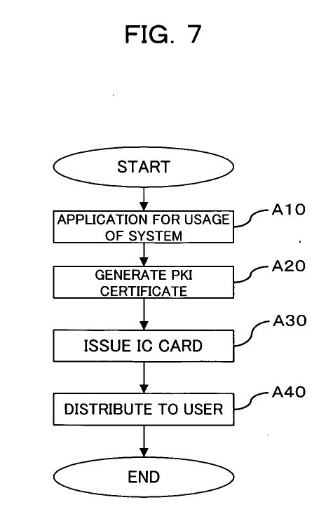

The processing of the authentication server 10 when a new user is registered (a preparation phase) in the delivery management system la according to the first embodiment of the present invention will be described in accordance with a flow chart (steps A10 to A40) shown in FIG. 7.

In the case of registering a new user, the user may file the application for usage of a system (step A10) and the PKI certificate issuing unit 11 may generate a PKI certificate (step A20).

Then, the authentication server 10 may store the secret key, the user ID, and the PIN and PKI certificates in the memory 61 of the IC card 60, may issue the IC card 10 (step A30), and may distribute this IC card 60 to the user (step A40).

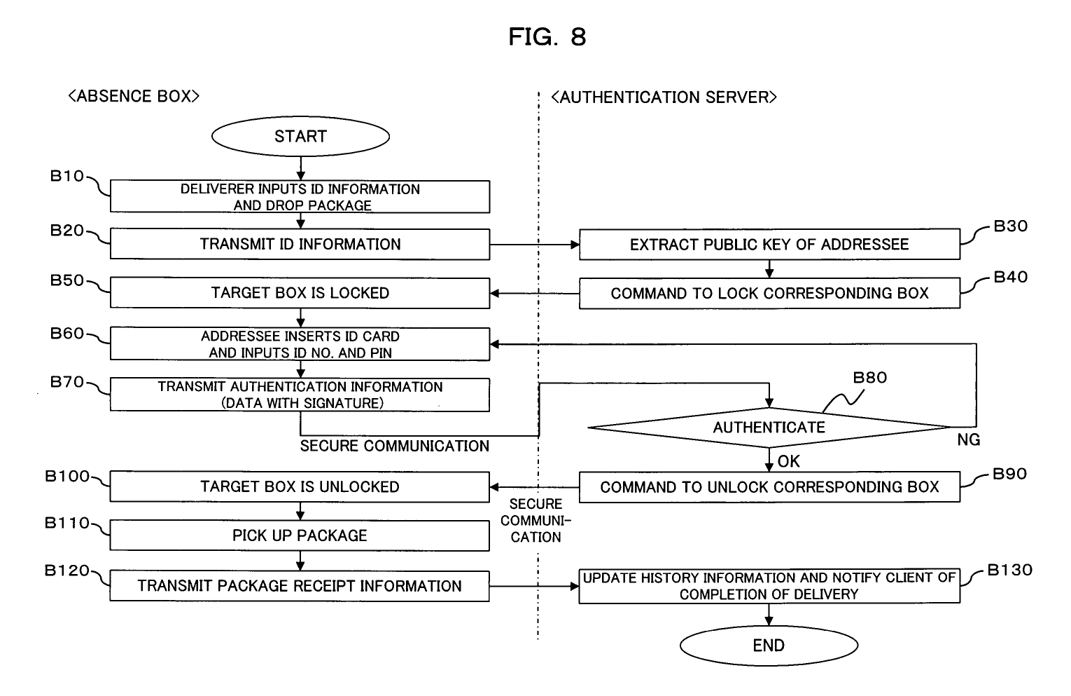

In the next place, the processing when the delivery management system la of the first embodiment according to the present invention is operated will be described in accordance with a flowchart shown in FIG. 8 (steps B10 to B130).

When the deliverer delivers the package, if the deliverer cannot directly deliver the package to the addressee due to absence of the addressee, the deliverer may input the client ID and the package ID in the absence box 20 by using the input key 22 and may drop the delivery in the delivery storage unit 27 (step B10).

The absence box 20 may transmit the user ID to the authentication server 10 via the communication network 50 (step B20). The authentication server 10 may extract the public key corresponding to the user ID from the public key database 12 on the basis of the received user ID (step B30), and may store this collected public key in storage means. In addition, the authentication server 10 may give a locking command to the locking unit 28 of the delivery storage unit 27 (step B30). In accordance with this locking command, in the absence box 20, the locking unit 28 may lock this delivery storage unit 27 (step B50).

Then, the addressee is notified that the delivery is stored in the absence box 20 by any means such as an absence notice and an electronic mail or the like, and by inserting the IC card 60 in the IC card reader 23, the addressee may read various kinds of information stored in the memory 61 and may input the PIN and the user ID or the like by using the input key 22 (step B60) In the absence box 20, the authentication data generating unit 25 may generate the data for authentication by adding an electronic signature to be created using the secret key acquired by the IC card reader 23 to the information for authentication including the addressee information, and the transmission unit 37 may transmit this generated data for authentication to the authentication server 10 through the secure communication (step B70).

In the authentication server 10, by creating and comparing the digests by using the public key acquired in the step B 30 and a hash function or the like, it is authenticated if the electronic signature added to the data for authentication is correct or not (step B80). If it is authenticated that the electronic signature is made by the addressee (refer to an OK route in the step B80), the control unit 13 of the authentication server 10 may transmit the unlocking command to the unlocking unit 29 of the storage unit with a key 26 through the secure communication (step B90).

On the other hand, if it is not authenticated that the electronic signature is made by the addressee (refer to an NG route of the step B80), the procedure may return to the step B60.

In the absence box 20, on receiving the unlocking command from the authentication server 10, the control unit 24 causes the unlocking unit 29 to unlock the storage unit with a key 26 (step B100). In addition, in the authentication server 10, the control unit 13 may update the status in the absence box information database 16.

If the addressee picks up the delivery from the delivery storage unit 27 (step B110), the package sensor 271 may detect that the package is picked up, and the control unit 24 may transmit the package receipt information to the authentication server 10 (step B120). In the authentication server 10, the control unit 13 may update the package information database 17 and may notify the client of the delivery that the delivery has been completed by means such as an electronic mail, a telephone, and a mailing card or the like (the delivery completion notice) (step B130) to complete the processing.

Thus, according to the delivery management system la of the first embodiment of the present invention, the addressee cannot directly receive the package and in order for the deliverer to pick up the delivery dropped in the storage unit with a key 26 of the absence box 20, by using the IC card reader 23 of this absence box 20, the addressee may input the secret key by the IC card 60 and the addressee is authenticated by using the secret key in the authentication server 10. Thereby, other person except for the addressee cannot pick up the package-from the absence box 20 and there is no possibility that an evil-minded person pretends to be the addressee to receive the package. In addition, it is possible to certainly manage and grasp that the delivery has been received by the addressee himself or herself and a reliability of delivery can be improved.

In addition, by giving the delivery completion notice to the client of the delivery using means such as an electronic mail, a telephone, and a mailing card or the like, this client also can certainly manage and grasp that the delivery has been received by the addressee himself or herself so as to improve a degree of satisfaction and a reliability.

### (B) Description of a Second Embodiment

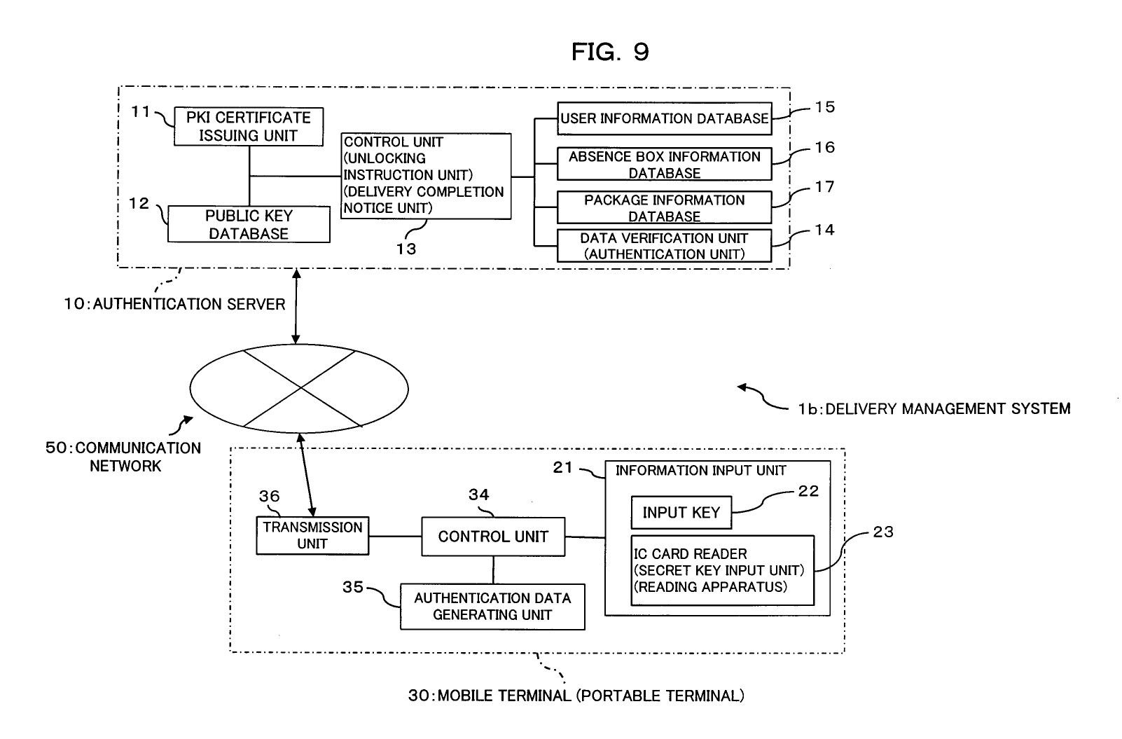

FIG. 9 is a pattern diagram showing a structure of a delivery management system of a second embodiment according to the present invention. A delivery management system 1b according to the second embodiment of the present invention also manages the information about a delivery (package) that is delivered to an addressee, and as shown in FIG. 9, is provided with a mobile terminal (a portable terminal) 30 in place of the absence box 20 in the delivery management system 1a according to the first embodiment.

In the meantime, in the drawing, the same reference numerals as those described above denote the same or similar parts, so that the detailed descriptions thereof are herein omitted.

In addition, also in the present delivery management system 1b, the user ID (Identification) for specifying the user is set for each of the users that are the addressees of the delivery, and for each user, a key pair of a public key and a secret key has been generated in advance, respectively.

Further, like the delivery management system la according to the first embodiment, each user has the IC card 60 (refer to FIG. 2) storing the secret key, the user ID, the PIN, and the PKI certificate in the memory 61.

For example, the mobile terminal 30 is the information processor that the deliverer can carry with himself or herself and when the deliverer delivers the delivery to the addressee, the deliverer carries out the authentication processing about the addressee by using this mobile terminal 30.

As shown in FIG. 9, this mobile terminal 30 is configured to be provided with an information input unit 21, a control unit 34, an authentication data generating unit 35, and a transmission unit 36.

The authentication data generating unit 35 may generate the data for authentication by adding the electronic signature created by using the secret key inputted by the IC card reader 23 to the information for authentication including the addressee information. In addition, as same as the authentication data generating unit 25 of the absence box 20 in the delivery management system la of the first embodiment according to the present invention, the authentication data generating unit 35 may generate the data for authentication (the data with a signature) about the addressee by adding the electronic signature and the information for a certificate to be created by using the secret key of the addressee that is acquired by the IC card reader 23 to the information for authentication (refer to FIG. 3) including the user ID read from the IC card 60 by the IC card reader 23 and the package ID inputted by the input key 22.

The transmission unit 36 may transmit the data for authentication generated by the authentication data generating unit 35 to the authentication server 10 via the communication network 50, and for example, is configured by, for example, a network device such as a LAN (Local Area Network) card and its control program or the like.

In addition, the transmission unit 36 may establish encrypted communication such as a SSL (Secure Socket Layer) with the authentication server 10, and thereby, the secure communication is made between the mobile terminal 30 and the authentication server 10.

The control unit 34 may control the authentication data generating unit 35, the IC card reader 33, and the transmission unit 37.

In addition, in the delivery management system 1b according to the second embodiment of the present invention, the deliverer may input the information about completion of deliver by using the input key 22 of the mobile terminal 30 after the deliverer delivers the package to the addressee, and the control unit 34 may transmit the package receipt information (deliver completion notice) to the authentication server 10 through the transmission unit 36 if such input is carried out.

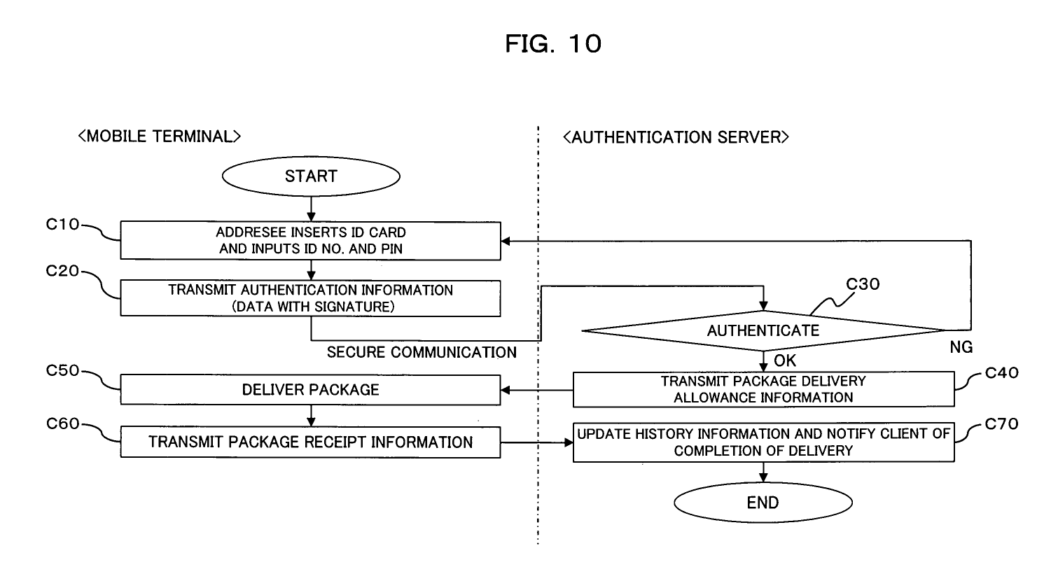

The processing when operating the delivery management system 1b of the second embodiment according to the present invention that is configured as described above will be described in accordance with the flowchart shown in FIG. 10 (steps C10 to C70).

The deliverer carries the mobile terminal 30 with him or her when delivering the package. Then, when delivering the delivery to the addressee, the addressee may insert the IC card 60 into the IC card reader 23 of the mobile terminal 30 and may input the PIN and the user ID or the like by using the input key 22 (step C10).

In the mobile terminal 30, the authentication data generating unit 35 may generate the data for authentication by adding the electronic signature created by using the secret key inputted by the IC card reader 23 to the information for authentication including the addressee information, and the transmission unit 37 may transmit this generated data for authentication to the authentication server 10 through the secure communication (step C20).

In the authentication server 10, by creating and comparing the digests by using the public key and the hash function or the like stored in the public key database 12, it is authenticated if the electronic signature added to the data for authentication is correct or not (step C30). If it is authenticated that the electronic signature is made by the addressee (refer to an OK route in the step C30), the control unit 13 of the authentication server 10 may transmit the package delivery allowance information to the mobile terminal 30 (step C40).

On the other hand, if it is not authenticated that the electronic signature is made by the addressee (refer to an NG route of the step C30), the procedure may return to the step C70.

In the mobile terminal 30, on receiving the package delivery allowance information from the authentication server 10, the control unit 34 may notify the deliverer that the package delivery allowance is received, for example, by displaying this on a display (its illustration is omitted) and the deliverer may deliver the delivery to the addressee in accordance with this package delivery allowance (step C50).

If the package has been completely delivered, the deliverer may input this in the mobile terminal 30, and the mobile terminal 30 may transmit the package receipt information (deliver completion notice) to the authentication server 10 (step C60). In the authentication server 10, the control unit 13 may update the package information database 17 and may notify the client that the delivery has been completed by means such as an electronic mail, a telephone, and a mailing card or the like (the delivery completion notice) (step C70) to complete the processing.

Thus, according to the delivery management system 1b of the second embodiment of the present invention, when the addressee directly receives the package, by using the IC card reader 23 of the mobile terminal 30, the addressee may input the secret key by the IC card 60 and the addressee is authenticated by using the secret key in the authentication server 10. Thereby, other person except for the addressee cannot pick up the package and there is no possibility that an evil-minded person pretends to be the addressee to receive the package. In addition, it is possible to certainly manage and grasp that the delivery has been received by the addressee himself or herself and a reliability of delivery can be improved.

In addition, by giving the delivery completion notice to the client of the delivery using means such as an electronic mail, a telephone, and a mailing card or the like, this client also can certainly manage and grasp that the delivery has been received by the addressee himself or herself so as to improve a degree of satisfaction and a reliability.

### (C) Description of a Third Embodiment

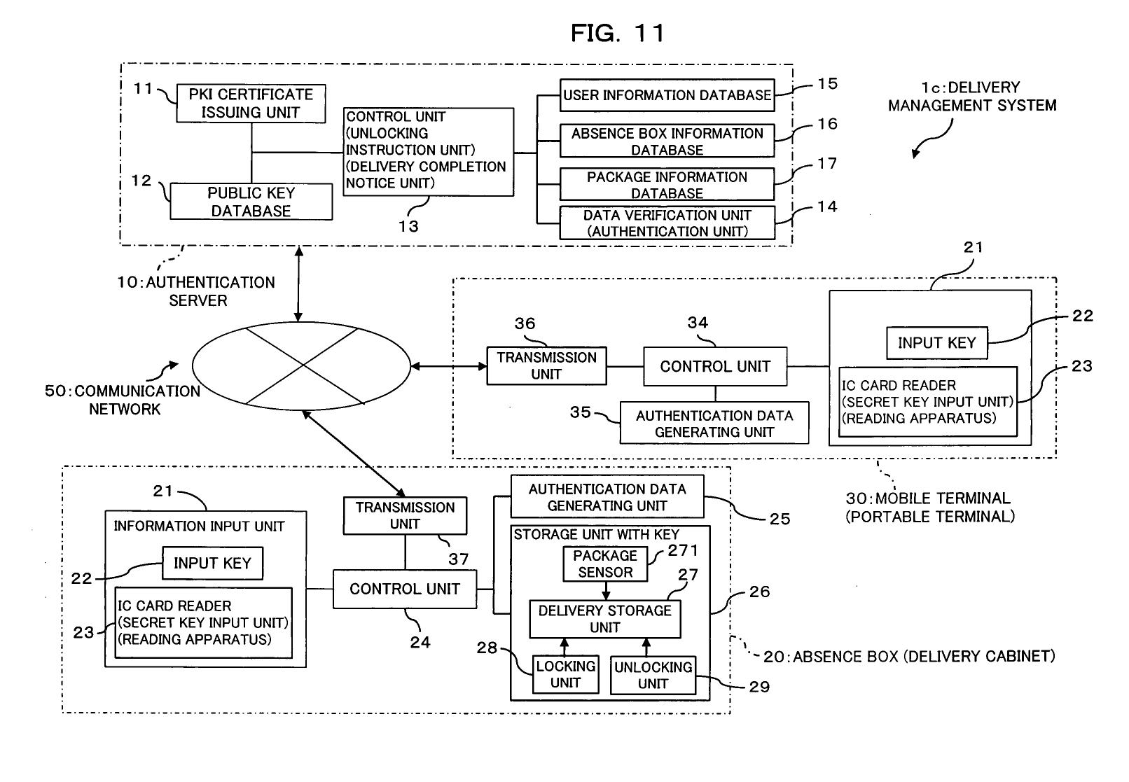

FIG. 11 is a pattern diagram showing a structure of a delivery management system of a third embodiment according to the present invention. A delivery management system 1c according to the third embodiment of the present invention also manages the information about a delivery (package) that is delivered to an addressee, and as shown in FIG. 11, is provided with the authentication server (the management server) 10, the mobile terminal (the portable terminal) 30 that is communicatably connected to this authentication server 10 via the communication network 50, and the absence box 20.

In the meantime, in the drawing, the same reference numerals as those described above denote the same or similar parts, so that the detailed descriptions thereof are herein omitted.

In the delivery management system 1c according to the third embodiment of the present invention that is configured as described above, when the deliverer delivers the package, if the deliverer can deliver the delivery directly to the addressee, the deliverer may carry out the authentication processing by using the mobile terminal 30, and if the deliverer cannot directly deliver the delivery to the addressee due to absence of the addressee, the deliverer may drop it in the absence box 20.

Thus, according to the delivery management system 1c according to the third embodiment of the present invention, the same operational advantages as the above-described first and second embodiments can be obtained. Further, when the deliverer delivers the package, in a case where the deliverer can directly deliver the delivery to the addressee, or in a case where the deliverer cannot deliver the delivery to the addressee due to absence of the addressee, it is possible to certainly manage and grasp that the delivery has been received by the addressee himself or herself so as to improve the reliability of the deliver. In addition, there is no possibility that an evil-minded person pretends to be the addressee to receive the package.

### (D) Others

The present invention is not limited to the above-described embodiments and various modifications will become possible without departing from the scope of the present invention.

For example, the above-described respective embodiments are configured in such a manner that the authentication server 10 is provided with the PKI certificate issuing unit 11, the public key database 12, and the data verification unit 14. However, the present invention is not limited to this and a function of at least one of these PKI certificate issuing unit 11, public key database 12, and data verification unit 14 may be provided to the absence box 20 and other information processor that is communicatably connected to the absence box 20 and the authentication server 10 via the communication network 50.

In addition, according to the above-described respective embodiments, the IC card is used as a medium for storing the user ID and the secret key. However, the present invention is not limited to this and for example, various kinds of recording media such as a magnetic card can be used.

Further, according to the above-described first and third embodiments, the package sensor 271 is realized by an optical sensor. However, the present invention is not limited to this, and for example, various modifications thereof such as a sensor for detecting whether or not the package is existing by its weight, and a sensor for detecting whether or not the package is existing by contacting thereto may be available.

Then, if respective embodiments of the present invention are disclosed, it is possible for a person skilled in the art to practice and manufacture the present invention.

For example, the present invention may be applicable to a deliver of a mail requiring a delivery record and a mail limited to the addressee.

What is claimed is:

1. A delivery management system for managing the information about a delivery delivered to an addressee, comprising:
a public key storage unit for storing a public key of the addressee;
a secret key input unit for inputting a secret key of the addressee; and
an authentication unit for authenticating the addressee on the basis of the secret key inputted by the secret key input unit and the public key stored in the public key storage unit.

2. The delivery management system according to claim 1, comprising a delivery cabinet and a management server communicatably connected to the delivery cabinet via a communication network, wherein
the delivery cabinet comprising:
the secret key input unit;
a delivery storage unit for storing the delivery delivered to the addressee;
a locking unit for locking the delivery storage unit;
an addressee information input unit for inputting the addressee information for specifying the addressee;
an authentication data generating unit for generating authentication data by adding a digital signature created by using the secret key inputted by the secret key input unit to authentication information including the addressee information;
a transmission unit for transmitting the authentication data generated by the authentication data generating unit to the management server via the communication network; and
an unlocking unit for unlocking the delivery storage unit, when the addressee is identified by the authentication unit, locked by the locking unit, wherein
the management server comprising the public key storage unit, the authentication unit, and unlocking instruction unit for instructing the unlocking unit to unlock the delivery storage unit when the addressee is identified by the authentication unit, wherein
the authentication unit authenticates the addressee by decoding the digital signature added to the authentication data transmitted from the transmission unit by using the public key; and
the unlocking unit unlocks the delivery storage unit in accordance with an unlocking instruction of the unlocking instruction unit.

3. The delivery management system according to claim 1, comprising a portable terminal that a deliverer can carry with him or her and a management server communicatably connected to the delivery cabinet via a communication network, wherein
the portable terminal comprising:
the secret key input unit;
an addressee information input unit for inputting the addressee information for specifying the addressee;
an authentication data generating unit for generating the authentication data by adding a digital signature created by using the secret key inputted by the secret key input unit to the authentication information including the addressee information; and
a transmission unit for transmitting the authentication data generated by the authentication data generating unit to the management server via the communication network, wherein the management server comprising the public key storage unit and the authentication unit; and wherein
the authentication unit authenticates the addressee by decoding the digital signature added to the authentication data transmitted from the transmission unit by using the public key.

4. The delivery management system according to claim 2, wherein
the authentication unit authenticates the addressee on the basis of the addressee information added with the authentication data and the public key.

5. The delivery management system according to claim 3, wherein
the authentication unit authenticates the addressee on the basis of the addressee information added with the authentication data and the public key.

6. The delivery management system according to claim 1, comprising a delivery completion notice unit for giving a notice of completion of the delivery to a person who requests delivery to the addressee when the addressee receives the delivery.

7. The delivery management system according to claim 2, comprising a delivery completion notice unit for giving a notice of completion of the delivery to a person who requests delivery to the addressee when the addressee receives the delivery.

8. The delivery management system according to claim 3, comprising a delivery completion notice unit for giving a notice of completion of the delivery to a person who requests delivery to the addressee when the addressee receives the delivery.

9. The delivery management system according to claim 4, comprising a delivery completion notice unit for giving a notice of completion of the delivery to a person who requests delivery to the addressee when the addressee receives the delivery.

10. The delivery management system according to claim 5, comprising a delivery completion notice unit for giving a notice of completion of the delivery to a person who requests delivery to the addressee when the addressee receives the delivery.

11. The delivery management system according to claim 1, wherein
the secret key of the addressee is readably stored in a medium that the addressee can carry with him or her, and
the secret key input unit is configured as a reading apparatus capable of reading the secret key from the medium.

12. The delivery management system according to claim 2, wherein
the secret key of the addressee is readably stored in a medium that the addressee can carry with him or her, and
the secret key input unit is configured as a reading apparatus capable of reading the secret key from the medium.

13. The delivery management system according to claim 3, wherein
the secret key of the addressee is readably stored in a medium that the addressee can carry with him or her, and
the secret key input unit is configured as a reading apparatus capable of reading the secret key from the medium.

14. The delivery management system according to claim 4, wherein
the secret key of the addressee is readably stored in a medium that the addressee can carry with him or her, and
the secret key input unit is configured as a reading apparatus capable of reading the secret key from the medium.

15. The delivery management system according to claim 5, wherein
the secret key of the addressee is readably stored in a medium that the addressee can carry with him or her, and
the secret key input unit is configured as a reading apparatus capable of reading the secret key from the medium.

16. The delivery management system according to claim 6, wherein
the secret key of the addressee is readably stored in a medium that the addressee can carry with him or her, and
the secret key input unit is configured as a reading apparatus capable of reading the secret key from the medium.

17. A delivery cabinet for keeping a delivery delivered to the addressee, comprising:
a delivery storage unit for storing the delivery that is delivered to the addressee;
a locking unit for locking the delivery storage unit;
a secret key input unit for inputting the secret key of the addressee; and
an unlocking unit for unlocking the delivery storage unit, when the addressee is identified as a result of authentication of the addressee carried out on the basis of the secret key inputted by the secret key input unit, that is locked by the locking unit.

18. The delivery cabinet according to claim 17, comprising:
an addressee information input unit for inputting the addressee information for specifying the addressee;
an authentication data generating unit for generating authentication data by adding a digital signature created by using the secret key inputted by the secret key input unit to authentication information including the addressee information; and
a transmission unit for transmitting the authentication data generated by the authentication data generating unit to the authentication server that is communicatably connected to the delivery cabinet via the communication network; wherein
the unlocking unit unlocks the delivery storage unit when the addressee is identified by the authentication server.

19. The delivery management system according to claim 17, wherein
the secret key of the addressee is readably stored in a medium that the addressee can carry with him or her, and
the secret key input unit is configured as a reading apparatus capable of reading the secret key from the medium.

20. The delivery management system according to claim 18, wherein
the secret key of the addressee is readably stored in a medium that the addressee can carry with him or her, and
the secret key input unit is configured as a reading apparatus capable of reading the secret key from the medium.
